(19) United States
(12) Patent Application Publication
(10) Pub. No.: US 2012/0013329 A1
(43) Pub. Date: Jan. 19, 2012

(54) ROTATION SENSOR DEVICE FOR WHEEL

(75) Inventors: Tadashi Hattori, Yokkaichi-city (JP); Kyungwoo Kim, Yokkaichi-city (JP)

(73) Assignee: SUMITOMO WIRING SYSTEMS, LTD., Yokkaichi-city, Mie (JP)

(21) Appl. No.: 13/259,689

(22) PCT Filed: Jan. 19, 2010
(86) PCT No.: PCT/JP2010/000271

§ 371 Date: Sep. 23, 2011

(30) Foreign Application Priority Data
Mar. 27, 2009 (JP) 2009-080526

(51) Int. Cl. G01B 7/30

(52) U.S. Cl. 324/207.25

(57) ABSTRACT

A rotation sensor device for a wheel including a core metal member configured to attach to an outer member of a wheel bearing device and having a containment recess protruding in a direction of a pulser ring provided on an inner member. The rotation sensor device further includes a sensing portion formed by molding a sensor element with a synthetic resin material as a separate component from the core metal member. The sensing portion is fixed within the containment recess and positioned opposite the pulser ring with a bottom wall of the containment recess positioned therebetween.

### CROSS-REFERENCE TO RELATED APPLICATIONS

This is a national stage application filed under 35 U.S.C. §371 claiming priority to International Application No. PCT/JP2010/000271 filed in Japan on Jan. 19, 2010, which claims priority to Japanese Application No. JP2009-080526 filed in Japan on Mar. 27, 2009, the disclosures of which are incorporated by reference herein in their entireties.

### BACKGROUND

Exemplary embodiments provided herein relate to a rotation sensor device for a wheel of a wheel bearing portion of an automobile or the like.

A rotation sensor device is typically attached to a wheel bearing portion of an automobile to detect wheel rotation speed for control on an anti-lock braking system (ABS).

Although some rotation sensor devices for a wheel include a structure that allows for direct attachment to the axle, most rotation sensor devices include a structure for attachment to an outer member of a wheel bearing device, such as structure supporting an inner member attached to the wheel in a rotatable manner, for example, as described in JP-A-2006-105185. In this example, a sensing portion of the rotation sensor is disposed opposite a pulser ring provided on the inner member. Accordingly, the rotation speed of the wheel is detected using the rotation sensor by detecting rotations of the pulser ring rotating together with the wheel as a flux change associated with rotations of the pulser ring.

Incidentally, the structure of the rotation sensor device in the related art requires a core metal member to attach the rotation sensor to the outer member. The core metal member is typically substantially cup-shaped and includes a drive shaft insertion hole at the center of its bottom wall for receiving a drive wheel. The core metal member is typically attached to the outer member as the peripheral wall opening thereof is firmly fixed to the outer member. Meanwhile, the core metal member is typically provided with a sensor attachment hole that penetrates through the bottom wall, and the rotation sensor is attached to the core metal member as the rotation sensor is fixed by insertion into the sensor attachment hole. With the rotation sensor inserted into the sensor attachment hole in the core metal member, the sensing portion protrudes from the core metal member and is exposed toward the pulser ring. The sensing portion is therefore disposed to directly oppose the pulser ring attached to the inner member.

The pulser ring, however, is provided in a bearing attachment region of the inner member and the outer member forming a wheel hub. The core metal member also functions as a shielding member that prevents the entrance of foreign matter by sealing the bearing attachment region from an outside space. However, because the structure of the rotation sensor device in the related art includes a sensor attachment hole penetrating through the core metal member, the reliability of the sealing performance in the bearing attachment region is compromised.

In order to ensure sealing performance in the bearing attachment region, the rotation sensor may be attached by press-fitting the rotation sensor into the sensor attachment hole in the core metal member without clearance therebetween. It can be, however, difficult to adequately control component dimensions during manufacturing to ensure sealing performance. Sealing using a sealing member may thus be applied after the rotation sensor is attached to the sensor attachment hole in the core metal member. However, it can be difficult to ensure sealing performance over time using this configuration.

### SUMMARY

Exemplary embodiments disclosed herein can provide a rotation sensor device for a wheel that includes a simple structure that allows for the attachment of a rotation sensor while improving reliability and sealing performance in a wheel bearing portion over time.

It should be appreciated that components disclosed in the respective embodiments described below can be combined in a variety of configurations where possible.

A rotation sensor device for a wheel according to an exemplary embodiment can include a core metal member having a circular outer circumference attached to an outer member of a wheel bearing device by supporting an inner member attached to a wheel in a rotatable manner by firmly fixing an outer circumference portion to the outer member. The rotation sensor device can support a sensing portion of a rotation sensor to be positioned opposite to a pulser ring provided in the direction of the inner member by fixing the rotation sensor to the core metal member. The rotation sensor device can include a bottomed containment recess protruding in the direction of the pulser ring on the core metal member, wherein the rotation sensor can be provided with a sensing portion by molding a sensor element with a synthetic resin material formed as a separate component from the core metal member, wherein fixing means for fixing the sensing portion of the rotation sensor to the containment recess in a state of being stored therein is provided, and wherein the sensing portion can be positioned opposite the pulser ring with a bottom wall of the containment recess therebetween.

In the rotation sensor device, the sensing portion can be fixed within the bottomed containment recess provided in the core metal member. As a result, an attachment hole provided through the core metal member may not be needed. Accordingly, sealing performance can be improved, and water and dust can be prevented from entering the wheel bearing device. Also, because there is no need to insert the sensing portion through the core metal member, the sensing portion can be attached to the core metal member by way of a simple structure.

Further, the sensing portion can be formed by molding the sensor element, and the rotation sensor, as a separate component from the core metal member. Thus, it is possible to position the sensor element more accurately. In other words, when the sensor element is formed integrally with the core metal member by molding, it can be difficult to position the sensor element within the relatively narrow containment recess. Accordingly, the sensor element can undergo positional displacement, which may lower performance. In contrast, in exemplary embodiments disclosed herein, the rotation sensor can be formed as a separate component by molding the sensor element, and then can subsequently be fixed in the containment recess. It thus becomes possible to position the sensor element more accurately. Various types of fixing means, such as bonding, press-fitting, caulking, riveting, and tight-fitting engagement are envisioned, either taken alone or in combination.

Various types of materials are envisioned for use in the construction of the core metal member and containment recess. Materials susceptible to eddy current losses, such as aluminum and copper, may be avoided.

The pulser ring can be of any type that produces a flux change in association with rotations detectable by the sensor element of the rotation sensor. The pulser ring may itself have a plurality of magnetic poles aligned circumferentially about the rotation center axis of the inner member, or may be of a type that does not have magnetic poles, but has a plurality of yoke forming protrusions made of a ferromagnetic material aligned circumferentially about the rotation center axis of the inner member, as long as the rotation sensor has magnetic poles.

The containment recess may be formed by inserting a cup-like fitting, molded separately from the core metal member, into an attachment hole provided in the direction of the core metal member in a corresponding shape, and tightly fixing the former to the latter by brazing or welding along the peripheral edge. It may, however, be preferable to adopt a configuration in which the containment recess is formed integrally with the core metal member by press fitting. When configured in this manner, sealing performance can be improved and part count can be reduced.

Further, direction determining means may be provided for specifying an attachment direction of the rotation sensor in the core metal member. When configured in this manner, erroneous attachment of the rotation sensor can be prevented. It thus becomes possible to specify a proper relative positional relationship of the sensing portion with respect to the circumferential direction of the pulser ring more readily, and in a more reliable manner, by specifying the directionality of the sensing portion when attached to the core metal member. Various structures can be suitably adopted as a specific structure of the direction determining means. For example, given corresponding positions on the inner circumferential surface of the containment recess and the outer circumferential surface of the rotation sensor to be fit therein can be provided, such as by providing a recess extending in the depth direction at one position and a protrusion fit in the recess at the other position, thus permitting insertion of the rotation sensor into the storing recess in a specific alignment orientation, or more simply, the containment recess may be formed with a substantially rectangular cross section, for example, as a cross section orthogonal to a line in the depth direction.

### BRIEF DESCRIPTION OF THE DRAWINGS

FIG. 1 is a cross section showing a wheel bearing device to which a rotation sensor device for a wheel is attached, according to one embodiment;

FIG. 2 is an enlarged view of a portion of FIG. 1;

FIG. 3 is a bottom plan view of a core metal member forming the rotation sensor device for a wheel shown in FIG. 1;

FIG. 4 is a cross section taken along line IV-IV of FIG. 3;

FIG. 5 is a bottom plan view of a core metal member having another configuration;

FIG. 6 is a cross section taken along line VI-VI of FIG. 5;

FIG. 7 is a cross section showing fixing means of another configuration;

FIG. 8 is a cross section showing fixing means of another configuration;

FIG. 9 is a cross section showing the core metal member of another configuration; and

FIG. 10 is a cross section showing the core metal member of another configuration.

### DETAILED DESCRIPTION OF THE EMBODIMENTS

The exemplary embodiments described herein are described with reference to the drawings.

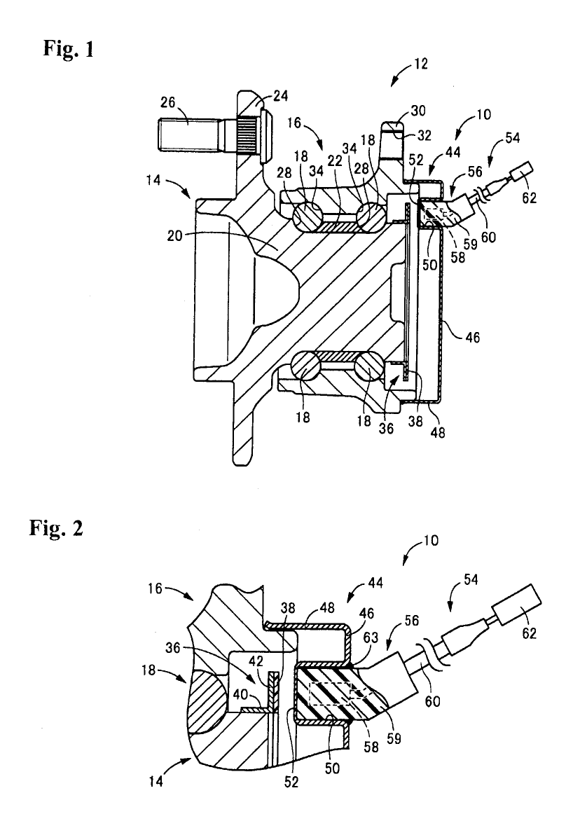

FIG. 1, in accordance with an exemplary embodiment, schematically shows a wheel bearing device 12 to which a rotation sensor device 10 for a wheel is attached. The wheel bearing device 12 is a wheel bearing device known in the related art for use with a driven wheel, and includes an inner member 14, an outer member 16, and rows of rolling elements 18 accommodated between the inner and outer members 14 and 16.

The inner member 14 includes a hub ring 20 and a separate inner ring 22 fixed to the hub ring 20 by external engagement. The hub ring 20 has a substantially solid rod shape, and a wheel attachment flange 24 for attaching a wheel is formed integrally in an outer circumferential portion thereof. Hub bolts 26, that fix the wheel, are attached to the wheel attachment flange 24 at circumferentially equally-spaced apart positions. The hub ring 20 and the inner ring 22 together form rows of inner rolling contact surfaces 28 on the outer circumference of the inner member 14.

The outer member 16 has a substantially tube shape, and a vehicle body attachment flange 30 for attachment to a vehicle body is formed integrally in an outer circumferential portion thereof. The outer member 16 is fixed to the vehicle body side with a bolt or the like using a bolt hole 32 provided on vehicle body attachment flange 30. Further, rows of outer rolling contact surfaces 34 opposing the inner rolling contact surfaces 28 of the inner member 14 are formed on the inner circumferential surface of the outer member 16.

As the inner member 14 is inserted into the outer member 16, the inner member 14 is supported on the outer member 16 in a rotatable manner via rows of the rolling elements 18 that are allowed to roll between the outer rolling contact surfaces 34 and the inner rolling contact surfaces 28. Although not shown, an appropriate sealing member, for example one made of rubber or the like, can be provided between the outer member 16 at an end on the wheel side (i.e., the end on the left in FIG. 1) and the inner member 14 to prevent water and dust from entering.

A pulser ring 38 is attached to the hub ring 20 at an end on the vehicle body side (i.e., the end on the right in FIG. 1) via a support 36. As is shown in FIG. 2, the support 36 has a circular tube 40 opening on both sides in the axial direction. A flange-like portion 42 extending outward along the radius is formed integrally with the circular tube 40 at one opening edge.

The pulser ring 38 can be made of a rubber magnet obtained by mixing an elastomer made of rubber, or the like, with ferromagnetic particles, such as ferrite, and shaped like an annular disc. North poles and south poles are alternately magnetized in the circumferential direction. It should be appreciated, however, that the pulser ring 38 is not necessarily constructed from an elastomer, and may, for example, be constructed from sintered metal obtained by compressing ferromagnetic particles made of ferrite or the like with a metal binder. As the pulser ring 38 formed as described above is attached to the flange-like portion 42 of the support 36, and the circular tube 40 of the support 36 is press-fit in or bonded to the hub ring 20 at the end on the vehicle body side in a state of external engagement, the pulser ring 38 is allowed to rotate integrally with the hub ring 20 about the center axis of the hub ring 20.

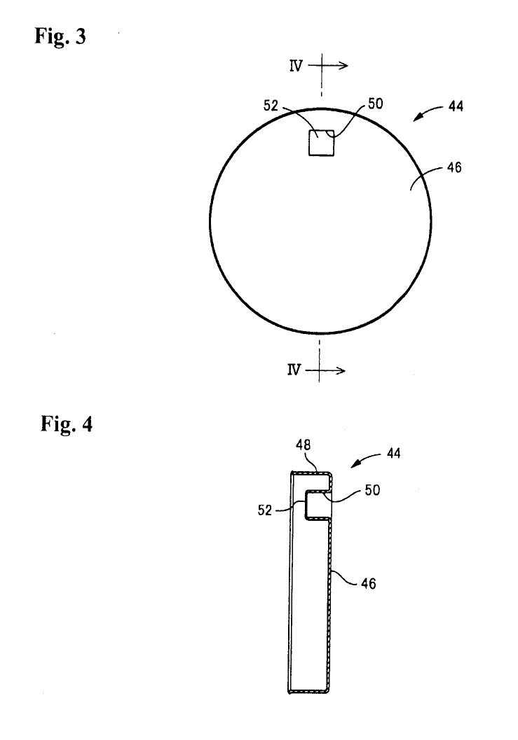

Meanwhile, a core metal member 44 is attached to the outer member 16 at the end on the vehicle body side (i.e., the end on the right in FIG. 1). FIG. 3 and FIG. 4 illustrate one embodiment of the core metal member 44. The core metal member 44 shown in the exemplary embodiment is substantially cup-shaped, and has a generally circular outer circumference, and in one embodiment, is obtained by integrally forming a bottom wall 46 having a substantially disc shape and a circumferential wall 48 extending upwardly from the entire outer circumferential edge of the bottom wall 46. The opening edge of the circumferential wall 48 expands slightly in diameter along the whole circumference to facilitate external engagement with the outer member 16. Further, a containment recess 50 that protrudes internally in the direction of the core metal member 44 (i.e., leftward in FIG. 4), and opening in a direction opposite to the opening direction of the core metal member 44 (i.e., leftward in FIG. 4), is provided on the bottom wall 46 in a region slightly offset outward along the radius thereof. The containment recess 50 has a bottom wall 52. As shown in FIG. 3, the containment recess 50 in this embodiment has a substantially rectangular cross section in a direction orthogonal to a depth direction of the containment recess 50 (i.e., the horizontal direction in FIG. 4). Further, the core metal member 44 in this embodiment, in particular, can be formed by pressing a metal plate, and the storing recess 50 can be formed integrally with the core metal member 44.

Examples of materials suitable for use in the core metal member 44 include, but are not limited to, austenite stainless steel plate (e.g., JIS-SUS 304 steel plate or the like) and rust-proofed cold rolled steel plate (e.g., JIS-SPCC steel plate or the like). Materials such as aluminum and copper may be avoided due to eddy current losses.

The peripheral wall 48 of the core metal member 44 is externally engaged with the outer member 16 at the end on the vehicle body side (i.e., the end on the right in FIG. 1) and fixed thereto by press-fitting or bonding. Accordingly, the entire opening in the outer member 16 on the vehicle body side is covered with the core metal member 44, thus preventing water and dust from entering the wheel bearing device 12. At the same time, as shown in FIG. 2, the bottom wall 52 of the containment recess 50 protrudes in the direction of the pulser ring 38 to be positioned opposite thereto at a certain distance therefrom in the axial direction (i.e., the horizontal direction in FIG. 2) of the wheel bearing device 12.

A sensing portion 56 of a rotation sensor 54 is fixed in the containment recess 50. The rotation sensor 54 is formed as a separate component from the core metal member 44. The sensing portion 56 can be formed by molding a magnetic detection IC chip 58 as a sensor element using a hall element or the like and a control circuit, when necessity arises, with, for example, epoxy resin 59. Further, one end of an output line 60 is electrically connected to the magnetic detection IC chip 58, while the other end of the output line 60 is connected to a connector 62. The rotation sensor 54 can be electrically connected to a control device, such as an ECU, via the connector 62.

The sensing portion 56 of the rotation sensor 54 is block-shaped and has a substantially rectangular cross section and fits into the containment recess 50 in the core metal member 44. The sensing portion 56, in a state of being fit in the containment recess 50, can be fixed to the core metal 44 by bonding with an adhesive 63 as a fixing means. Consequently, in this embodiment, the rotation sensor device 10 for a wheel can include the rotation sensor 54 and the core metal member 44. The magnetic detection IC chip 58 provided on the sensing portion 56 is positioned opposed and spaced-apart from the pulser ring 38, with the bottom wall 52 of the containment recess 50 therebetween in the axial direction of the wheel bearing device 12. In this configuration, fluctuation in the magnetic field caused by rotations of the pulser ring 38 can be detected and converted to an electric signal by the magnetic detection IC chip 58 provided on the sensing portion 56, and the resulting electric signal can be transmitted to the control device, such as an ECU, via the output line 60 and the connector 62.

According to the embodiment of the rotation sensor device 10 for a wheel having the structure as described above, the sensing portion 56, in a state of being stored in the containment recess 50, is fixed therein, and therefore attached without penetrating through the core metal member 44. Thus, not only is it possible to attach the sensing portion 56 to the core metal member 44 with a simple structure, it is possible to improve secure sealing performance at the attachment portion of the rotation sensor 54 over time and with higher reliability using a simple configuration and without requiring a hole through the core metal member 44. It is thus possible to prevent water and dust from entering into the wheel bearing device 12 at the attachment portion of the rotation sensor 54. In this embodiment, in particular, because the containment recess 50 is molded integrally with the core metal member 44, secure sealing performance can be achieved.

Further, in this embodiment, the sensing portion 56 provided with the magnetic detection IC chip 58 can be formed as a separate component from the core metal member 44 and later fixed to the core metal member 44. Consequently, for example, in comparison with a case where the magnetic detection IC chip 58 is molded along with the core metal member 44, it is possible to position the magnetic detection IC chip 58 more accurately in the containment recess 50, and thus more accurately with respect to the pulser ring 38.

In addition, in this embodiment, because the containment recess 50 and the sensing portion 56 have rectangular cross sections that correspond to each other, the sensing portion 56 is attached to the containment recess 50 in a specific orientation. Thus, the cross sections of the containment recess 50 and the sensing portion 56 serve as an insertion guide, thus reducing the risk of erroneous attachment and preventing positional displacement of the sensing portion 56 when engaged within the containment recess 50.

In addition, in this embodiment, because the containment recess 50 is cup-shaped, the containment recess 50 occupies a smaller portion in the core metal member 44 in the circumference direction. Hence, the strength of the core metal member 44 can be maintained. It thus is possible to lower the risk that the core metal member 44 undergoes deformation when attached to the outer member 16, and facilitates stability with respect to the position of the sensing portion 56.

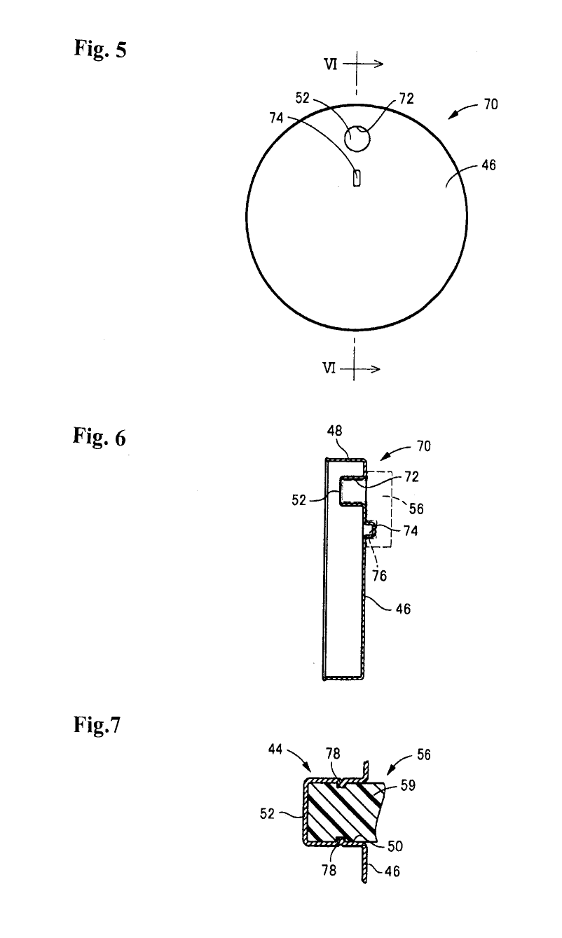

While an exemplary embodiment has been described above, it should be appreciated that, for example, a specific shape of the containment recess is not limited to the shape described in the embodiment above. Referring to the core metal member 70 shown in FIGS. 5 and 6, the containment recess 72 can have a circular cross section. In a case where the containment recess 72 has a circular cross section, it is preferable to provide a positioning protrusion 74 and a positioning recess 76 that fit together at the periphery of the containment recess 72 and the sensing portion 56, respectively. In this configuration, the positioning protrusion 74 and the positioning recess 76 together form a direction determining means.

The containment recess is not necessarily required to be molded integrally with the core metal member. For example, the containment recess may be formed using a bottomed cup-like fitting formed as a separate component from the core metal member so that the cup-like fitting can be inserted into an attachment hole provided in the core metal member in a corresponding shape and tightly fixed by brazing or welding along the peripheral rim. In such a case, it may be preferable to form a flange extending outwardly along the radius in an opening peripheral edge of the cup-like fitting, followed by brazing or the like along the flange.

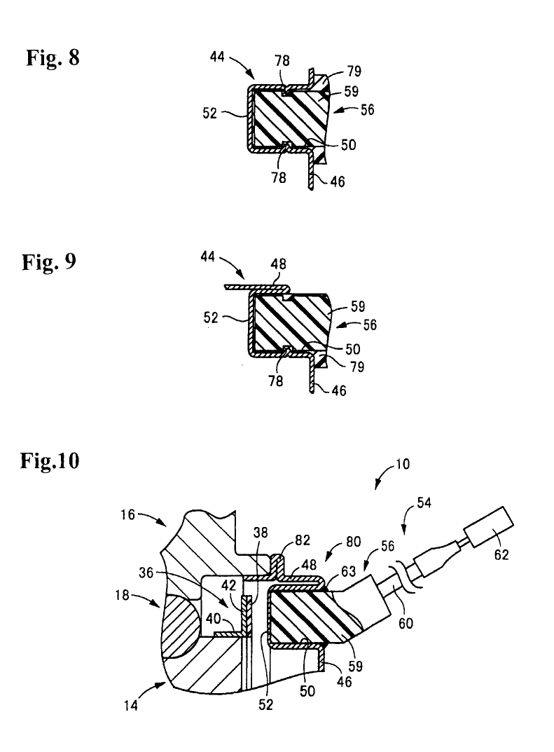

This specific configuration for the fixing means for fixing the sensing portion to the core metal member is not intended to be limited to the above embodiment. Instead of, or in addition to, the bonding described in the embodiment above, various fixing methods known to those skilled in the art are envisioned. In particular, because the sealing performance in the rotation sensor attachment portion can be ensured by the bottomed containment recess, a degree of selective freedom for the fixing means can be enhanced. For example, as shown in FIG. 7, a recess 78 opening on the outer circumferential surface may be provided in the direction of the sensing portion 56 to fix the storing recess 50 by caulking forced in the recess 78, so that the fixing means includes the recess 78. Alternatively, as shown in FIG. 8, the containment recess 50 and the sensing portion 56 may be molded with a synthetic resin material, for example, epoxy resin 79, to provide the sensing portion 56 in the containment recess 50 by insert molding, so that the epoxy resin 79 is used as the fixing means. Further, in FIG. 8, fixing the recess 78 by caulking in the same manner as in FIG. 7 can also used as the fixing means together with the epoxy resin 79.

Further, the position of the containment recess can be set by taking into account the position of the pulser ring attached to the wheel bearing device. For example, as shown in FIG. 9, the containment recess 50 may be formed in the outer circumferential edge of the core metal member 44. In the sensing portion 56 of FIG. 9, the recess 78 can be fixed to the core metal member 44 as it is fixed, by caulking, in the inside wall of the containment recess 50 in the radial direction of the core metal member 44 and molded with the epoxy resin 79. Further, as is known, an opposing direction of the pulser ring and the sensing portion is not limited to the rotation center axis direction of the wheel bearing device. For example, in a case where the pulser ring and the sensing portion are opposed to each other in a direction orthogonal to the rotation center axis of the wheel bearing device, the containment recess 50 may be formed so as to protrude internally in the direction of the wheel bearing device from the peripheral wall 48 of the core metal member 44 in the embodiment above in a direction orthogonal to the rotation center axis of the wheel bearing device, so that the bottom wall 52 of the containment recess 50, and hence the sensing portion 56 stored therein, are disposed opposite to the pulser ring in a direction orthogonal to the rotation center axis of the wheel bearing device.

Also, as shown in FIG. 10, the core metal member 80 can internally engage the outer member 16. The core metal member 80 can be provided with a positioning portion 82 formed as an integral part thereof by bending the peripheral wall 48 so as to extend outward from the peripheral wall 48. The core metal member 80, in a state of internal engagement, can be attached to the outer member 16 as it is inserted therein until it is locked to the positioning portion 82. When configured in this manner, it is possible to accurately set a spacing distance between the pulser ring 38 and the sensing portion 56.

The embodiment above describes one configuration in which the rotation sensor device for a wheel can be attached to the wheel bearing device on the driven wheel side. However, the rotation sensor device for a wheel can also be attached to the wheel bearing device on the drive wheel side. In such a case, the core metal member can have a substantially annular shape having a drive wheel insertion hole penetrating through the core metal member at the center.

Those skilled in the art will appreciate that the exemplary embodiments provided herein can be configured for use with magnetoresistive elements, magnetic pickup methods using a wound coil, and the like.

1. A rotation sensor device for a wheel, comprising:
a core metal member having a circular outer circumference configured to attach to an outer member of a wheel bearing device by fixing an outer circumference portion of the core metal member to the outer member, the core metal member having a bottomed containment recess thereon protruding in a direction of a pulser ring; and
a rotation sensor including a sensing portion having a sensor element molded with a synthetic resin configured to be received within the containment recess;
wherein the sensing portion is positioned opposite the pulser ring with a bottom of the containment recess positioned therebetween.

2. The rotation sensor device for a wheel according to claim 1, wherein:
the containment recess is integrally formed with the core metal member.

3. The rotation sensor device for a wheel according to claim 1, further comprising:
direction determining features for specifying an attachment direction of the rotation sensor in the containment recess.

4. The rotation sensor device for a wheel according to claim 1, wherein the containment recess protrudes internally in a direction of the core metal member and opens in a direction opposite to the opening of the core metal member.

5. The rotation sensor device for a wheel according to claim 1, wherein the containment recess is provided on a bottom of the core metal member in a region offset outward along the radius thereof.

6. The rotation sensor device for a wheel according to claim 1, wherein the bottomed containment recess has a substantially rectangular cross section in a direction orthogonal to a depth direction of the containment recess.

7. The rotation sensor device for a wheel according to claim 1, wherein the sensing portion of the rotation sensor has a substantially rectangular cross section.

8. The rotation sensor device for a wheel according to claim 1, wherein the core metal member and the containment recess are separate components fixed together.

9. The rotation sensor device for a wheel according to claim 1, wherein the sensing portion is fixed within the containment recess.

10. The rotation sensor device for a wheel according to claim 1, wherein the core metal member and the rotation sensor are formed as separate components.
